(19) United States
(12) Patent Application Publication
(10) Pub. No.: US 2026/0160334 A1
(43) Pub. Date: Jun. 11, 2026

(54) SEAL FOR SEALING BETWEEN MULTIPLE PANELS

(71) Applicant: ROLLS-ROYCE PLC, London (GB)

(72) Inventors: Gaetano ARENA, Derby (GB); Cameron BRETT, Derby (GB); James THORP, Derby (GB); George T ASHLEY, Derby (GB); Ed WHEATCROFT, Derby (GB); Alberto PIRRERA, Derby (GB); Rainer M. GROH, Derby (GB); Mark SCHENK, Derby (GB)

(73) Assignee: ROLLS-ROYCE PLC, London (GB)

(21) Appl. No.: 19/178,273

(22) Filed: Apr. 14, 2025

(30) Foreign Application Priority Data
Apr. 26, 2024 (GB) 2405890.1

(51) Int. Cl. F16J 15/10; F01D 11/00

(52) U.S. Cl. CPC F16J 15/104; F01D 11/00; F05D 2220/32; F05D 2240/55

(57) ABSTRACT

A seal arrangement providing a seal between three or more relatively moveable panels having gaps therebetween. A seal element comprises a nexus and plurality of legs each of the legs radiating from the nexus along a respective gap. Each leg comprises a cover spaced from the panels and straddling a gap and a first flange connected to a first of the panels separated by the respective gap and a second flange connected to a second of the panels separated by the respective gap.

### CROSS REFERENCE TO RELATED APPLICATIONS

This represents the first application directed towards the subject-matter.

### FIELD

This disclosure relates to seals and seals between three or more panels that can move relative to each other.

### BACKGROUND

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20. A core exhaust nozzle 24 is also provided to help control the mixing of bypass and core air flows.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan. In some configurations there may be a secondary combustion downstream of the turbine with may be used to generate further thrust.

Leakage in gas turbines is a significant source of inefficiency and seals are regularly used to provide a fluid seal between adjacent components. Components may move relative to each other in use because of thermal expansion (or other reasons) and the seals aim to provide a fluid seal between adjacent components throughout the engines operational window.

Seals between two adjacent panels that can move relative to each other are known. However, where seals are required to minimise fluid leakage between three or more panels that may move relative to each other conventional seals may not be able to accommodate such movement without creating unacceptable gaps or without applying unacceptable stress to the panels.

### SUMMARY

It is an object of this disclosure to seek to provide a seal that seeks to address this and other problems.

According to an aspect of the invention there is provided a seal arrangement for providing a seal between three or more relatively moveable panels having gaps therebetween, the arrangement comprising three or more relatively moveable panels and a seal element; wherein the seal element comprises a nexus and plurality of legs each of the legs radiating from the nexus along a respective gap; wherein each leg comprises a cover spaced from the panels and straddling a gap and a first flange connected to a first of the panels separated by the respective gap and a second flange connected to a second of the panels separated by the respective gap.

The three or more relatively moveable panels may twist, pitch and/or yaw relative to each other or may translate to or from each other.

The nexus, cover and first and second flanges may together provide an impermeable barrier.

Each of the nexus, cover, first flange and/or second flange may have different flexibility.

Each of the nexus, cover, first flange and/or second flange may comprise one or more portions of higher stiffness and lower stiffness. The relative stiffness may be provided by regions of different thickness, regions of different materials and/or regions with curves or angles.

The, or each, portion of higher stiffness and/or lower stiffness may repeat in series.

The, or each, portion of higher and/or lower stiffness may induce buckling of the nexus, cover, first flange and/or second flange upon relative movement of the panels.

The movement of the panels may be one or more of twisting out of plane, twisting in plane, or transverse.

The panels may be triangular, square, rectangular or hexagonal.

The panels may be planar or curved.

The seal arrangement may comprise a plurality of panels tessellating across an area

The seal arrangement may comprise multiple nexus and legs extend between adjacent nexi.

There may be provided a method of making a seal arrangement comprising the steps of providing a panel substrate and forming a seal element thereon using an additive process.

The additive process may be selected from a group comprising a solid based process, a blown powder based process, a powder bed process, a liquid based process, or a gaseous based process.

The panel substrate may be separated into three or more panels after the seal element is formed.

The panel substrate may comprise three or more panels before the seal element is formed.

According to an aspect there is provided a seal element for a seal arrangement.

### BRIEF DESCRIPTION OF THE DRAWINGS

Embodiments will now be described by way of example only with reference to the accompanying drawings, which are purely schematic and not to scale, and in which:

FIG. 1 depicts a schematic of a gas turbine;

FIG. 2 shows a plan view surface made of four square panels;

FIG. 3 shows a plan view of the surface of FIG. 2 with a sealing element sealing the gaps between the panels;

FIG. 4 is a side view of the panel and sealing element of FIG. 3 along line A-A or B-B;

FIG. 5 is a side view of the panel and sealing element of FIG. 3 along line C-C or D-D;

FIG. 6a, FIG. 6b, FIG. 6c, FIG. 6d, FIG. 6e, FIG. 6f depict first, second, third, fourth, fifth and sixth alternative profiles respectively of the sealing elements;

FIG. 7 depicts a perspective view of a four panel omega profiled seal;

FIG. 8 depicts a perspective view of a four panel triangular profiled seal;

FIG. 9 depicts a perspective view of a four panel complex profiled seal;

FIG. 10 depicts a perspective view of a corner of a further complex profiled seal;

FIG. 11 depicts a top view of a seal joining panels to a further out of plane panel;

FIG. 12 is a side view of FIG. 11;

FIGS. 13a and 13b are further embodiments of FIG. 2 and FIG. 3 where the panels are triangular;

FIGS. 14a and 14b are further embodiments of FIG. 2 and FIG. 3 where the panels are hexagonal;

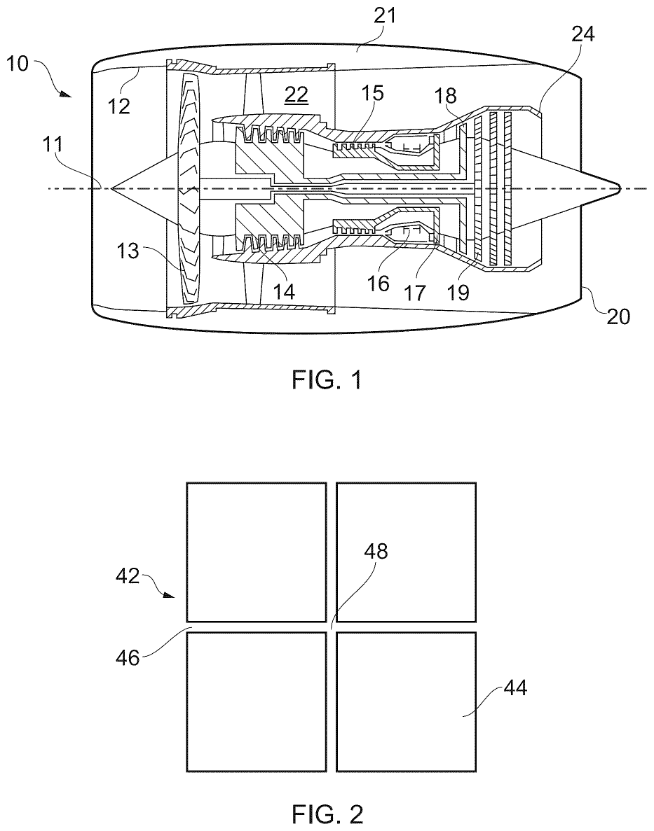

### DETAILED DESCRIPTION

FIG. 2 depicts a plan view of a panel 42 made up of four separate panel elements 44. In some uses of the panel it is necessary for the panels to move relative to each other. The panel movement may be twisting from the intersection 48 of the four panels, laterally towards or away from an adjacent panel, or a combination of these movements.

Such uses of the panel may be, for example, in the exhaust section of a gas turbine engine where multiple panel elements may be used to provide a cylindrical, or rectangular exhaust which contain gasses at temperatures above 400° C. and with a significant pressure difference between the inside of the exhaust and the outside of the exhaust.

For such a use any gaps in the panel 42 between the panel elements 44 are undesirable as any gas leaving the exhaust can no longer be used to generate thrust and the high temperatures of the gas, if allowed to leave the confines of the exhaust, could damage some more temperature sensitive components.

Although planar panel elements are depicted the panels may curve out of plane to provide an arcuate or cylindrical component.

The panels may move laterally relative to each other. The lateral movement may be +/−10 mm with a maximum gap between the panels of 10 mm and a minimum gap of 0 mm. The panels may also move orthogonally to each other. The orthogonal movement may be +/−6 mm from a design alignment. In the embodiment shown the design alignment is where the adjacent panel elements, if their surfaces were extended, would intersect. However, in other embodiments the design alignment may see one of the panel elements lying out of plane with an adjacent panel element. The panel elements may also pitch relative to each other. The pitch movement may be +/−2°. The panel elements may also yaw relative to each other. The yaw movement may be +/−2°.

To prevent leakage of air through the gaps 46 a seal element is provided that is able to withstand the high temperature changes and pressure differentials whilst accommodating all relative movements between panels and survive for many cycles of engine operation—one cycle is a flight involving take-off and landing.

The seal is unitary in that it is formed as one piece either as a separate unit that is subsequently joined to the panel members of built directly onto the panel members using an additive manufacture process such as a powder bed or blown powder.

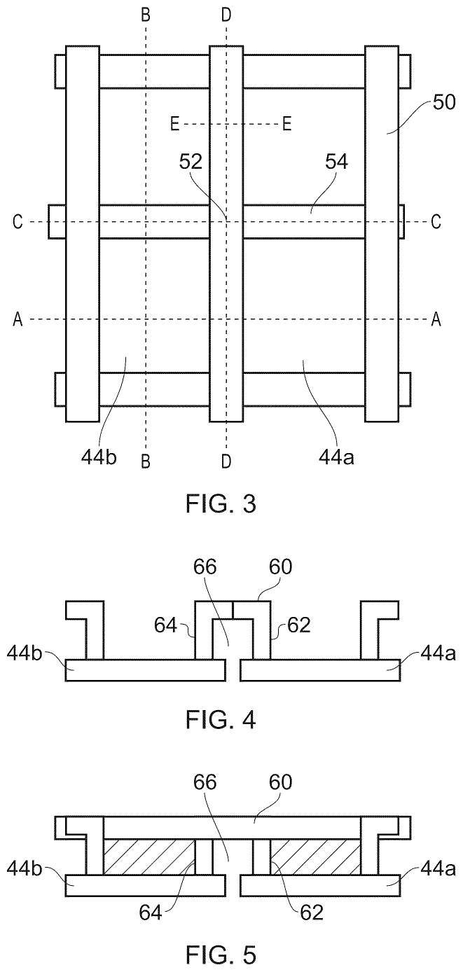

A plan view of the seal element is shown in FIG. 3 and a side view of the seal along lines A-A and/or B-B in FIG. 4 and a side view along lines C-C and/or D-D in FIG. 5. In FIGS. 3, 4 and 5 there are further panel elements (not shown) located adjacent the four panel elements that are shown.

For a given intersection 48 the seal element 50 radiates from a nexus 52 with legs 54 associated with each of the gaps 46 between the panel elements 44a, 44b. Each of the legs has a cover 60 from which flanges 62, 64 extend to join the cover to the panel elements. The flanges extend in a substantially orthogonal direction to the plane of the panel elements. The cover 60 straddles the gap 46 with one of the flanges 62 being 20 joined to a first one of the panel elements 44a and a second one of the flanges 64 being joined to a second one of the panel elements 44b. As the panels have more than two edges the flange that is joined to a respective panel element may extend along multiple edges of the flange. The nexus and cover is spaced from the panel elements by the height of the flange.

First flange 62, second flange 64 and cover 60 is made out of metal, or high temperature resistant plastic and is sufficiently stiff to maintain overall panel 42 conformity whilst permitting each of the panel elements 44 to move relative to each other.

The seal element is more flexible than the panel elements and will morph, or shape-change, in preference to the panel elements when the panel elements move relative to each other.

The seal element may exploit variable stiffness, compliant mechanisms and/or structural nonlinear behaviour to allow the seal element to withstand large deformations without incurring catastrophic failure. The stiffness can be tailored to provide required load-carrying capabilities and withstand aerodynamic loads without incurring in-flight flutter.

The seal element is able to adapt its shape when subjected to external loads and strains and is able to maintain its sealing function when the panels move and rotate relative to each other. At the same time, due to the nature of the material, the seal can withstand the temperature and pressures involved when used within the exhaust of gas turbines.

The length of each of the flanges and/or cover may be between 10 mm and 80 mm, or 10 mm and 70 mm, or 10 mm and 60 mm or 10 mm and 50 mm. The length of a flange and cover may be the same. The length of a flange and cover may be different. The length of each flange may be different. Where the flanges, and cover are provided by a curved construction with no obvious corners the length of the seal element may be between 20 mm and 240 mm or 20 mm and 220 mm or 20 mm and 200 mm.

The material of the seal element may be selected to withstand temperatures up to 1000° C. The material of the seal element may be selected to withstand temperatures above 300° C., or above 400° C., or above 500° C., or above 600° C., or above 700° C.

The seal element may survive a delta pressure up to 1 MPa. The seal element may survive a delta pressure above 0.3 MPa, or above 0.4 MPa, or above 0.5 MPa, or above 0.6 MPa, or above 0.7 MPa.

In the embodiment of FIGS. 3, 4 and 5 the compliance is provided by the choice of material, the length and thickness of the cover 60 and flanges 62, 64 and the design of the corners between the cover and the flange.

It is possible to adjust the way the seal element morphs in relation to the panel movement by altering its characteristic. As a first option one or more regions in the cover and/flanges may be provided that are thicker or thinner than other regions in the cover and/or flanges. This may cause selective buckling at the thinner regions. As a further option the cover and/or flanges may comprise kinks or curves that provide one or more further hinge points and/or corrugations.

The seal element may be formed by additive manufacture for example powder based processes, liquid based processes, solid based processes or gaseous based processes.

In solid based processes a wire is traversed over a surface and a high energy beam is used to melt the wire into a melt-pool. When the melt-pool cools it leaves a deposit with a height which may be used to support a subsequent deposit formed by a subsequent pass of the wire and high energy beam. In this way an article can be formed having a complex three-dimensional shape.

In a first powder based process a nozzle is traversed over a surface that ejects a powder into a melt pool formed by a high energy beam. When the melt-pool cools the powder leaves a deposit with a height which may be used to support a subsequent deposit formed by a subsequent pass of the nozzle and high energy beam. In this way an article can be formed having a complex three-dimensional shape.

In a further powder based process a layer of powder is provided over which a high energy beam is passed to melt and fuse a portion of the powder layer. The layer is then indexed vertically and new layer of powder deposited on top. In a subsequent pass of the high energy beam the new layer is selectively melted to join portions thereof onto the previously melted layer. Once all layers have been melted and cooled the unfused/melted powder is removed to leave an article which may have a complex three-dimensional shape.

In a liquid based process a metal is deposited by electrolysis onto a temporary preform that may be removed afterwards to leave a free standing or hollow part.

In a gaseous based process a metal is deposited by vacuum technologies such as physical vapour deposition (PVD) where the metal ion for deposition is released from a target material by magnetron sputtering, electron beam evaporation or other high energy process onto a temporary preform that may be removed afterwards to leave a free standing or hollow part. Chemical vapour deposition may be used as an alternative to PVD.

Where a preform is used this may be removed from the article by heating to above the melting temperature of the preform, by thermal degradation, or by exposure to low temperatures (e.g. to fracture brittle substrates).

The preform may be removed from the article by making it from a material that dissolves in a solution that does not dissolve the manufactured article. Soluble substrates may include substrates that are acid soluble, base soluble, organic solvent soluble, water soluble, or otherwise dissolvable (e.g. a soluble polymer).

The preform may be formed from a wax material which may be filled or a non-filled. The wax may be a blend of petroleum waxes, natural waxes and/or resins. The wax may further comprise fillers. The preform may be a soluble polymer (e.g. polystyrene, polyvinyl chloride, polylactic acid, polylactic-co-glycolic acid). The soluble polymer may be obtained through plastic extrusion or moulding or using a three-dimensional printed model. Suitable three-dimensional printed materials also include wax.

The seal element may be modified post manufacture e.g. by laser treatment to tailor some of the local thicknesses and adjust its response due to relative movement of the panels.

One of the advantages of using an additive process to manufacture the seal element is that it can be formed either separately from the panel elements and subsequently joined thereto, or it can be formed integrally with the panels. A further advantage is that it allows for the seals to have complex cross-sectional shapes.

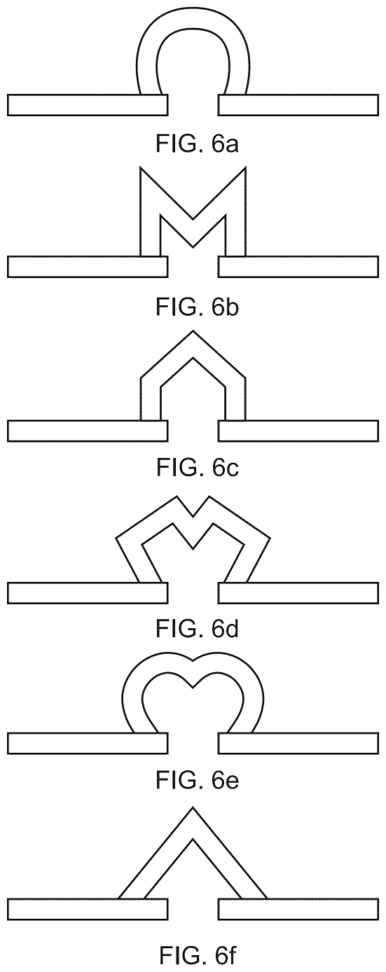

As shown in FIG. 6, FIG. 6b, FIG. 6c, FIG. 6d, FIG. 6e and FIG. 6f which are simplistic side view of alternative seal element cross-sections taken across line E-E of FIG. 3. The seal element cross-section may be curved or the cover and/or legs may comprise multiple angles or sections. In the shapes with curves the removal of sharp corners which may extend the life of the seal element. For shapes with multiple angles or sections each angle or section may be used to set a tailored response of the seal element to a particular type of relative movement of the panel elements.

One of the particular challenges in a system with three or more panel elements, which isn't seen when there are just two panel elements to seal, is that each panel is constrained by the seal element along at least two edges and requires a nexus capable of allowing appropriate movement of each of the panel elements. The nexus is designed such that each flange 62, 64 radiating from the nexus operates substantiality independently of the other flanges 62, 64 radiating from the nexus.

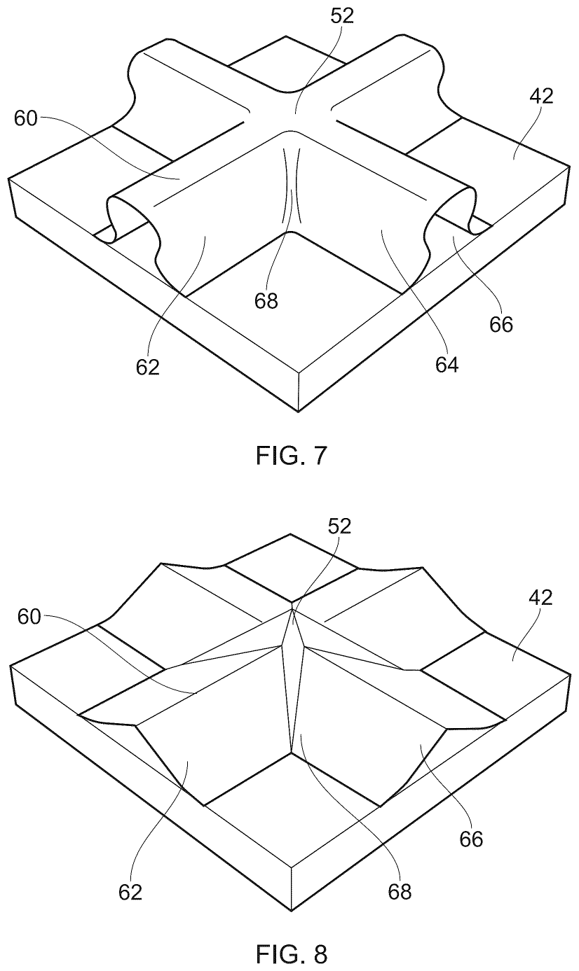

FIG. 7 depicts a perspective view of the Omega shaped seal element of FIG. 6a for a panel having four panel elements. A chamber 66 is bounded by the seal element on one side and the four independently moveable panel elements on the other side. Any fluid passing through the panel gaps is retained within the seal chamber 66. A dimple 68, or hollow, is located on the side of the nexus at the intersection of two flanges 62. 64 to allow each to move in response to panel element movement and the pitch and twist that primarily affects those flanges 62. 64 that are at right angles to each other.

FIG. 8 depicts a perspective view of the “V” shaped seal element of FIG. 6f for a panel having four panel elements. A chamber 66 is bounded by the seal element on one side and the four independently moveable panel elements on the other side. Any fluid passing through the panel gaps is retained within the seal chamber 66. At the join of two flanges 62, 64 at the nexus 52 a defined, but contiguous crease, allows each panel element to move substantially independently of the other panels.

In the above two embodiments, where the shape of the seal element is relatively simple it is possible to form the seal element through a mould process where the sheet blank is pressed into a mould to form a structure that is subsequently brazed or welded onto the panel elements. As the complexity of the seal element increases it becomes more beneficial to use some of the additive processes described above.

In FIG. 9 the cover 52 comprises a trough, in a similar manner to FIGS. 6b, 6d and 6e, and the nexus 52 comprises an inversion.

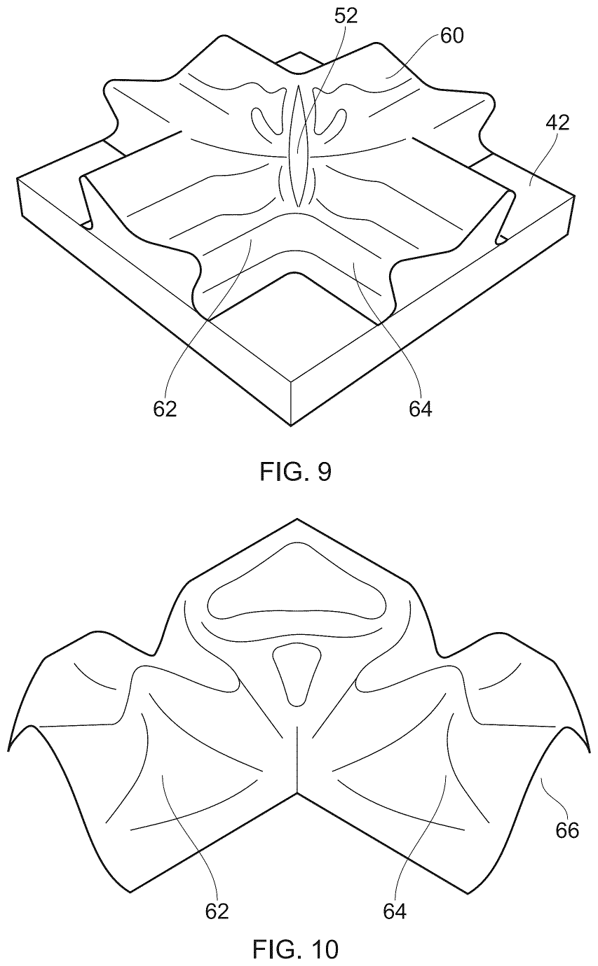

FIG. 10 shows a portion of a more optimised seal element where additional notches 70 and dimples 68 provide regions of increased flexibility which assists each flange 62, 64 to operate independently.

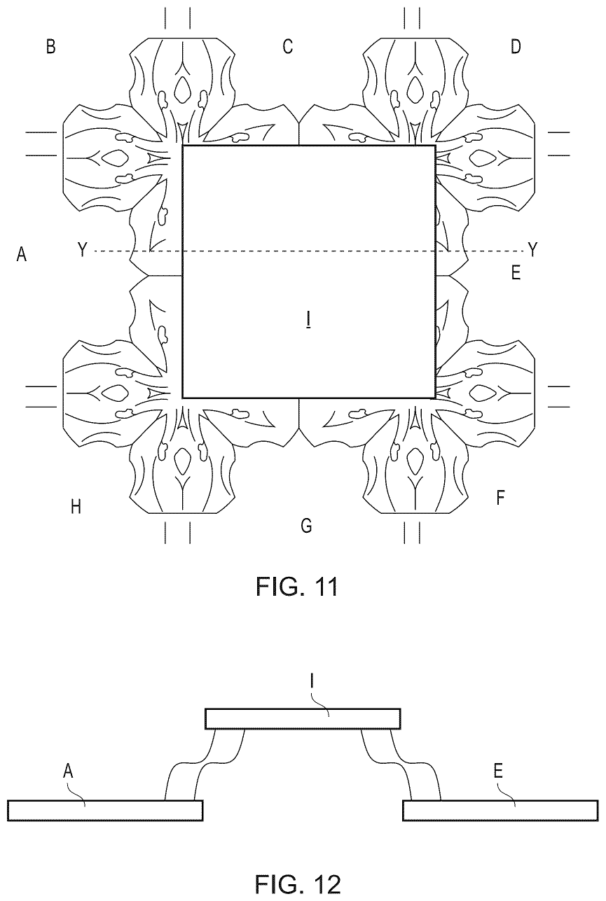

Further flexibility for the seal may be achieved by placing panels in layers. In the embodiment of FIG. 11 eight panel elements (A-F) are arranged as a single layer with a centrally positioned panel (I) located out of plane with the other panels. In this embodiment the centrally positioned panel (I) acts as part of the seal element and cover from which the flanges extend to join the panels. FIG. 12 is a side view of the arrangement of FIG. 11 along line Y-Y and which show a that the flanges 12 have a curved profile that further enhances movement in a direction orthogonally to the general plane of the panel.

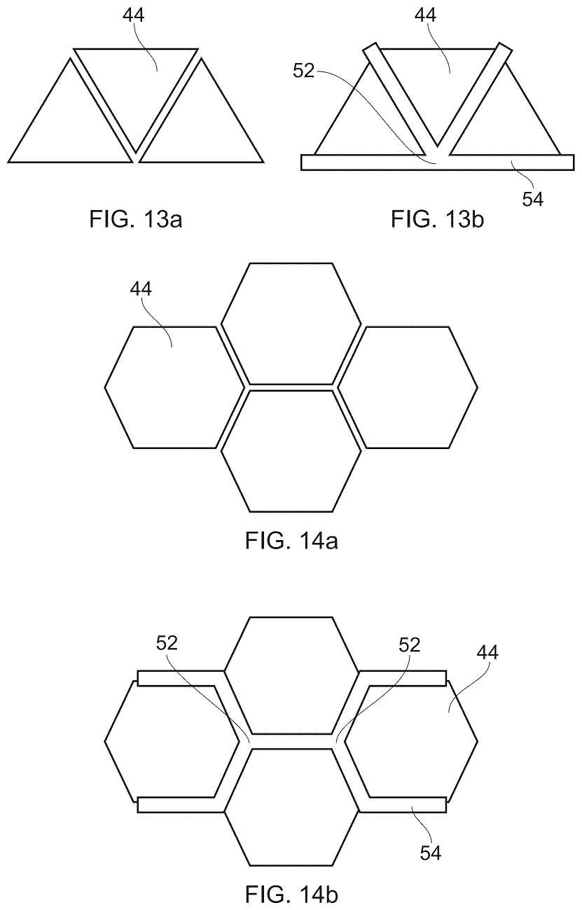

Although in the previous figures the panels have been shown to be square/rectangular it is possible to use other shapes. Preferably the shape of each panel is the same and will preferably tesselate over substantially the full surface. Accordingly, the panels may be triangular as shown in FIG. 13a,b or hexagonal as shown in FIG. 14a, b.

The final design of the component is tailored to the specific application conditions and can assume a set of shapes and geometries depending on the design and manufacturing requirements.

Various examples have been described, each of which comprise various combinations of features. It will be appreciated by those skilled in the art that, except where clearly mutually exclusive, any of the features may be employed separately or in combination with any other features and the invention extends to and includes all combinations and sub-combinations of one or more features described herein.

1. A seal arrangement for providing a seal between three or more relatively moveable panels having gaps therebetween, the arrangement comprising three or more relatively moveable panels and a seal element;
wherein the seal element comprises a nexus and plurality of legs each of the legs radiating from the nexus along a respective gap;
wherein each leg comprises a cover spaced from the panels and straddling a gap and a first flange connected to a first of the panels separated by the respective gap and a second flange connected to a second of the panels separated by the respective gap, wherein each flange extends from the panel in an orthogonal direction.

2. A seal arrangement according to claim 1, wherein the nexus, cover and first and second flanges together provide an impermeable barrier.

3. A seal arrangement according to claim 2, wherein each panel has at least two edges and wherein the flange connected to a respective panel extends along multiple edges of the panel.

4. A seal arrangement according to claim 3, wherein the nexus, cover, first flange and/or second flange have different flexibility.

5. A seal arrangement according to claim 4, wherein the nexus, cover, first flange and/or second flange comprise portions of higher stiffness and lower stiffness.

6. A seal arrangement according to claim 5, wherein the portions of higher stiffness and lower stiffness repeat in series.

7. A seal arrangement according to claim 1, wherein the portion of higher and lower stiffness induce buckling of the nexus, cover, first flange and/or second flange upon relative movement of the panels.

8. A seal arrangement according to claim 7, wherein movement of the panels is one or more of twisting out of plane, twisting in plane, or transverse.

9. A seal arrangement according to claim 1 wherein the panels are triangular, square, rectangular or hexagonal.

10. A seal arrangement according to claim 1, wherein the panels are planar or curved.

11. A seal arrangement according to claim 1, comprising a plurality of panels tessellating across an area.

12. A seal arrangement according to claim 11, wherein the seal element comprises multiple nexus and legs extend between adjacent nexi.

13. A seal arrangement for providing a seal between three or more relatively moveable panels having gaps therebetween, the arrangement comprising three or more relatively moveable panels and a seal element;
wherein the seal element comprises a nexus and plurality of legs each of the legs radiating from the nexus along a respective gap;
wherein each leg comprises a cover spaced from the panels and straddling a gap and a first flange connected to a first of the panels separated by the respective gap and a second flange connected to a second of the panels separated by the respective gap, wherein each flange extends from the panel in an orthogonal direction and the cover and nexus are spaced from the panels by the height of the flanges.

14. A seal arrangement according to claim 13, wherein each panel has at least two edges and wherein the flange connected to a respective panel extends along multiple edges of the panel.

15. A seal arrangement according to claim 1 wherein the panels are triangular, square, rectangular or hexagonal.

16. A seal arrangement according to claim 1, wherein the panels are planar or curved.

17. A seal arrangement according to claim 15, comprising a plurality of panels tessellating across an area.

18. A seal element comprising a nexus and plurality of legs each of the legs radiating from the nexus;
wherein each leg comprises a cover and first and second flanges which extend from the cover in an orthogonal direction;
and wherein each flange is continuous between adjacent legs.

19. A seal element according to claim 18, wherein the nexus, cover, first flange and/or second flange have different flexibility.

20. A seal arrangement according to claim 18, wherein the nexus, cover, first flange and/or second flange comprise portions of higher stiffness and lower stiffness.
